(19) United States
(12) Patent Application Publication
(10) Pub. No.: US 2025/0143274 A1
(43) Pub. Date: May 8, 2025

(54) FISHING REEL

(71) Applicant: Shimano Inc., Osaka (JP)

(72) Inventor: Kunio TAKECHI, Sakai, Osaka (JP)

(21) Appl. No.: 18/918,859

(22) Filed: Oct. 17, 2024

(30) Foreign Application Priority Data
Nov. 7, 2023 (JP) 2023-189992

(51) Int. Cl. A01K 89/033

(52) U.S. Cl. CPC A01K 89/033

(57) ABSTRACT

A fishing reel includes a reel body, a first side cover, a spool, a braking device, a first operating member, a second operating member, and a controller. The reel body has a first side plate and a second side plate, a first side cover disposed on the first side plate. The spool is disposed between the first side plate and the second side plate. The braking device brakes rotation of the spool. An exposed portion is exposed by the first side cover. A portion of the second operating member is exposed by the first side cover. The controller controls the braking force of the braking device in accordance with the operating positions of the first operating member and the operating position of the second operating member.

### CROSS-REFERENCE TO RELATED APPLICATIONS

This application claims priority to Japanese Patent Application No. 2023-189992, filed on Nov. 7, 2023. The entire disclosure of Japanese Patent Application No. 2023-189992 are hereby incorporated by reference.

### BACKGROUND

### Technical Field

The present disclosure relates to a fishing reel.

### Background Information

In conventional fishing reels, dual-bearing reels can include a spool braking device to prevent backlash during casting. See for example, Japanese Laid Open Patent Application No. 2007-135417 which discloses a spool braking device that controls braking force of a spool in accordance with operating positions of two operating members.

### SUMMARY

It has been determined that in a fishing reel equipped with a braking device that controls the braking force of a spool in accordance with operating positions of two operating members, it is desirable that the operability of the two operating members is improved.

An object of the present disclosure is to improve the operability of two operating members for adjusting the braking force of the spool.

In accordance with a first aspect of the present disclosure, a fishing reel basically comprises a reel body having a first side plate and a second side plate, a cover disposed on the first side plate, a spool disposed between the first side plate and the second side plate, a braking device that brakes the rotation of the spool, a first operating member, a portion of which is exposed from the cover, a second operating member, a portion of which is exposed from the cover, and a control device that controls the braking force of the braking device in accordance with an operating position of the first operating member and an operating position of the second operating member.

In this fishing reel, both the first operating member and the second operating member are exposed from the cover, so that the operability of the two operating members (first and second operating members) can be improved, compared to a case in which the first operating member and/or the second operating member is not exposed from the cover.

In accordance with a second aspect of the present disclosure, a fishing reel basically comprises a reel body having a first side plate and a second side plate, a cover disposed on the first side plate, a spool disposed between the first side plate and the second side plate, a braking device that brakes the rotation of the spool, a first operating member that can be operated in a rotational direction of the spool, a second operating member that can be operated in the rotational direction of the spool, and a control device that controls the braking force of the braking device in accordance with an operating position of the first operating member and an operating position of the second operating member.

In this fishing reel, both the first and second operating members can be operated in the rotational direction of the spool, so that the operability of the two operating members can be improved.

In accordance with a third aspect of the present disclosure, the fishing reel in accordance with the first or second aspect, the first operating member of the present disclosure has a first operating axis positioned inside an outer shape of the cover as viewed from a first direction along a rotational axis of the spool, and the second operating member has a second operating axis positioned inside the outer shape or dimension of the cover as viewed from the first direction. In this case, the size of the fishing reel can be reduced, and the operability of the two operating members can be further improved.

In accordance with a fourth aspect of the present disclosure, in the fishing reel in accordance with any one of the first to the third aspects of the present disclosure, the first operating member and the second operating member are disposed inside the outer shape or dimension of the cover as viewed from the first direction. In this case, the size of the fishing reel can be reduced, and the operability of the two operating members can be further improved.

In accordance with a fifth aspect of the present disclosure, in the fishing reel in accordance with any one of the first to the fourth aspects of the present disclosure, the second operating member is disposed further inward of the cover than the first operating member, as viewed from the first direction. In this case, the size of the fishing reel can be reduced, and the operability of the two operating members can be further improved.

In accordance with a sixth aspect of the present disclosure, in the fishing reel in accordance with any one of the first to the fifth aspects of the present disclosure, a spool of the fishing reel has a bobbin trunk, a first flange portion disposed on the first side plate side of the bobbin trunk, and a second flange portion disposed on the second side plate side of the bobbin trunk, and the first operating member and the second operating member are disposed inside an outer shape of the first flange portion as viewed from the first direction. In this case, the size of the fishing reel can be reduced, and the operability of the two operating members can be further improved.

In accordance with a seventh aspect of the present disclosure, in the fishing reel in accordance with any one of the first to the sixth aspect of the present disclosure, a cover of the fishing reel has an opening to accommodate the first operating member and the second operating member. In this case, the operability of the two operating members can be further improved.

In accordance with an eighth aspect of the present disclosure, in the fishing reel in accordance with any one of the first to the seventh aspects of the present disclosure, an opening of the cover is positioned in front of and above a rotational axis of the spool as viewed from the first direction. In this case, the operability of the two operating members can be improved, and erroneous operation of the first operating member and the second operating member can be suppressed, such as when palming.

In accordance with a ninth aspect of the present disclosure, in the fishing reel in accordance with the seventh aspect or the eighth aspect of the present disclosure, an opening of the fishing reel has a first opening for accommodating the first operating member, and a second opening for accommodating the second operating member. In this case, the operability of the two operating members can be further improved.

In accordance with a tenth aspect of the present disclosure, in the fishing reel in accordance with the ninth aspect of the present disclosure, the first operating member of the fishing reel protrudes from the first opening in a radial direction of a rotational axis of the spool, as viewed from the first direction, and the second operating member protrudes from the second opening in a radial direction of the rotational axis of the spool, as viewed from the first direction. In this case, the operability of the two operating members can be further improved.

In accordance with an eleventh aspect of the present disclosure, in the fishing reel in accordance with any one of the first to the tenth aspects of the present disclosure, the first operating member or the second operating member can be rotated around the rotational axis of the spool. In this case, the operability of the two operating members can be further improved.

In accordance with a twelfth aspect of the present disclosure, in the fishing reel in accordance with any one of the first to the tenth aspects of the present disclosure, the first operating member and the second operating member can be rotated around the rotational axis of the spool. In this case, the operability of the two operating members can be further improved.

In accordance with a thirteenth aspect of the present disclosure, in the fishing reel in accordance with any one of the first to the twelfth aspects of the present disclosure, the first operating member includes a first detected portion and a first support portion that supports the first detected portion, the second operating member includes a second detected portion and a second support portion that supports the second detected portion, the control device includes a first sensor for detecting the position of the first detected portion and a second sensor for detecting the position of the second detected portion, and the first detected portion, the first support portion, the second detected portion, and the second support portion are arranged inside the outer shape or dimension of the cover as viewed from the first direction. In this case, the size of the fishing reel can be further reduced.

According to the fishing reel of the present disclosure, it is possible to improve the operability of two operating members for adjusting the braking force of a spool.

### BRIEF DESCRIPTION OF THE DRAWINGS

FIG. 1 is a plan view of a fishing reel.

FIG. 2 is a left side view of the fishing reel.

FIG. 3 is a partial cross-sectional view of the fishing reel.

FIG. 4 is a block diagram of a control device.

FIG. 5 is an exploded perspective view of the control device.

FIG. 6 is a perspective view of a first side cover, a first operating member, and a second operating member.

FIG. 7 is a side view of the first side cover, the first operating member, and the second operating member.

### DETAILED DESCRIPTION OF EMBODIMENTS

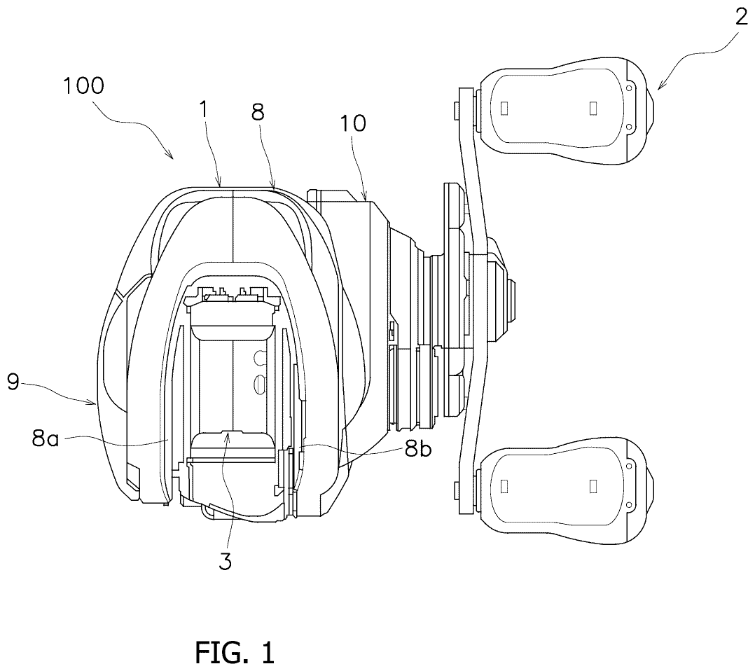

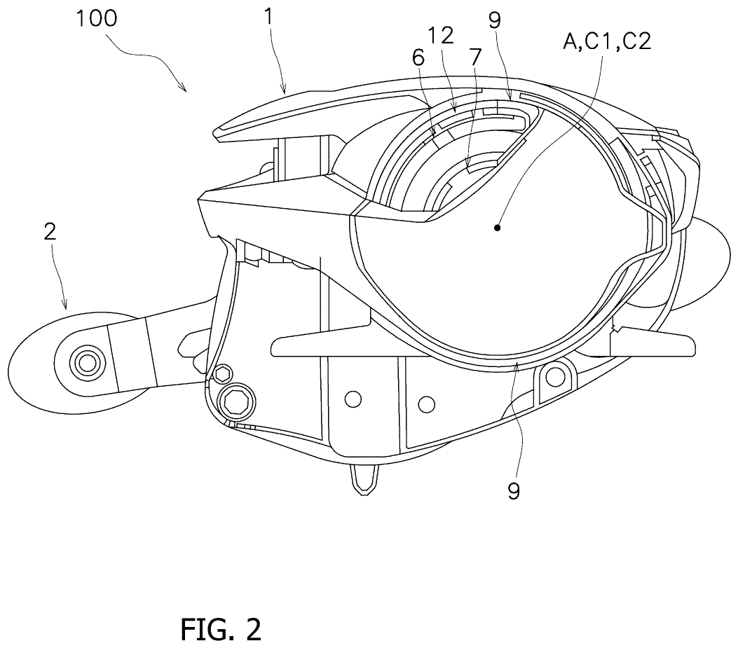

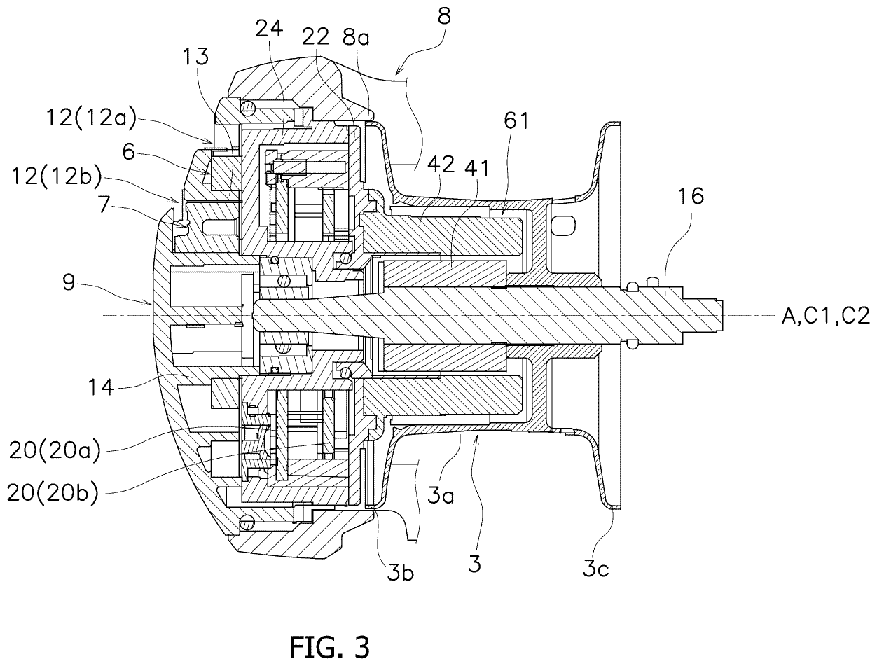

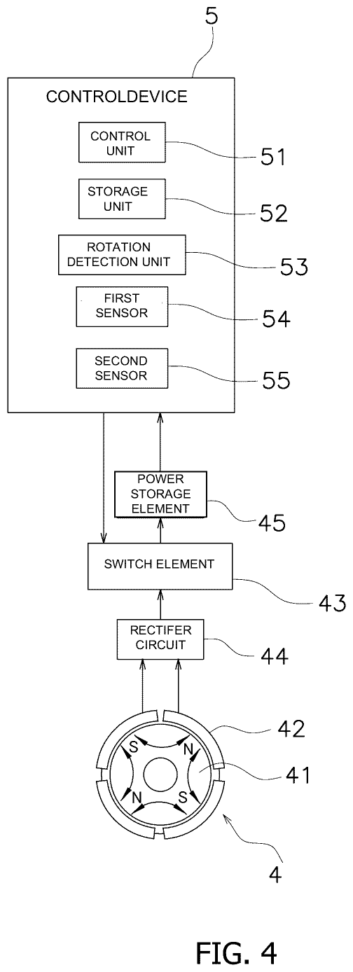

A fishing reel 100 according to one embodiment of the present disclosure is a dual-bearing reel. As shown in FIGS. 1 to 4, the fishing reel 100 comprises a reel body 1, a handle 2, a spool 3, a braking device (brake) 4, a control device (controller) 5, a first operating member (first operator) 6, and a second operating member (second operator) 7.

The reel body 1 includes a frame 8, a first side cover 9 (one example of a cover), and a second side cover 10. The frame 8 has a first side plate 8a, and a second side plate 8b. The first side plate 8a is disposed on the opposite side of the frame relative to the handle 2. The second side plate 8b is disposed spaced apart from the first side plate 8a in the axial direction. The axial direction is a direction along a rotational axis A of the spool 3.

The first side cover 9 is disposed on the first side plate 8a. The first side cover 9 is disposed axially outward of the first side plate 8a. The second side cover 10 is disposed on the second side plate 8b. The second side cover 10 is disposed axially outward of the second side plate 8b.

The first side cover 9 has an essentially circular shape as viewed from the axial direction. The first side cover 9 has an opening 12, a first supporting protrusion 13, and a second supporting protrusion 14. The opening 12 accommodates the first operating member 6 and the second operating member 7. The opening 12 is positioned in front of and above the rotational axis A of the spool 3 as viewed from the axial direction. The opening 12 is opened in the axial direction as well as a radial direction perpendicular to the axial direction. The opening 12 opens in an upward and forward direction.

The opening 12 includes a first opening 12a and a second opening 12b. The first opening 12a and the second opening 12b extend in an arc shape as viewed from the axial direction. The first opening 12a and the second opening 12b also extend in a circumferential direction as viewed from the axial direction. The circumferential direction is the circumferential direction of a circle centered on the rotational axis A of the spool 3. The first opening 12a accommodates the first operating member 6. The first opening 12a is disposed on an outer peripheral side (radially outer side) of the second opening 12b. The circumferential dimension of the first opening 12a is larger than the circumferential dimension of the second opening 12b. The second opening 12b accommodates the second operating member 7. The second opening 12b is disposed at a position closer to the rotational axis A of the spool 3 than the first opening 12a.

The first supporting protrusion 13 and the second supporting protrusion 14 are disposed on the inner side of the first side cover 9. The first supporting protrusion 13 and the second supporting protrusion 14 are formed in an annular shape. The first supporting protrusion 13 and the second supporting protrusion 14 extend in the axial direction. The first supporting protrusion 13 is disposed on the outer peripheral side of the second supporting protrusion 14.

The handle 2 is attached to the reel body 1 so as to be rotatable. The handle 2 is arranged adjacent to the second side cover 10. The rotation of the handle 4 is transmitted to the spool 3 via a rotation transmission mechanism, which is not shown.

The spool 3 is supported by the reel body 1 so as to be rotatable. The spool 3 is disposed between the first side plate 8a and the second side plate 8b. The spool 3 is connected to a spool shaft 16 so as to be integrally rotatable therewith. The spool shaft 16 is supported by the reel body 1 so as to be rotatable. The spool 3 has a bobbin trunk 3a, a first flange portion 3b, and a second flange portion 3c. A fishing line is wound around the bobbin trunk 3a. The first flange portion 3b is disposed on the first side plate 8a side of the bobbin trunk 3a. The second flange portion 3c is disposed on the second side plate 8b side of the bobbin trunk 3a.

The braking device 4 is configured to brake the rotation of the spool 3. The braking device 4 brakes the spool 3 in an electrically controllable manner. The braking device 4 includes a magnet 41, a plurality of coils 42, and a switch element 43.

The magnet 41 rotates integrally with the spool 3. The magnet 41 is fixed to the spool shaft 16, for example. The magnet 41 can be fixed to the spool 3. The magnet 41 has a cylindrical shape. The magnet 41 has a plurality of magnetic poles that are anisotropically magnetized. The magnetic poles of the magnet 41 are arranged alternately in the circumferential direction.

The plurality of coils 42 are connected to each other in series. The plurality of coils 42 are tubular in shape. The plurality of coils 42 are arranged on the radially outer side of the magnet 41. The plurality of coils 42 and the magnet 41 are spaced apart from each other. The plurality of coils 42 can be rotated relative to the magnet 41. The plurality of coils 42 are connected to a circuit board 20 that includes two boards 20a, 20b. The two ends of the plurality of coils 42 are electrically connected to the switch element 43. The circuit board 20 is housed between a coil support member 22 that supports the plurality of coils 42 and a board case 24 that is fixed to the coil support member 22.

The switch element 43 is composed of a field effect transistor, for example. The switch element 43 is connected to the coils 42 via a rectifier circuit 44. In addition, the switch element 43 is connected to a power storage element 45. The power storage element 45 stores power generated by the coils 42 at the time of casting. The power storage element 45 functions as a power source that supplies power to electrical components connected to the braking device 4 and the control device 5. The power storage element 45 is composed of an electrolytic capacitor, for example.

The control device 5 controls the braking force of the braking device 4 in accordance with the operating positions of the first operating member 6 and the operating position of the second operating member 7. The control device 5 turns an electrical current on and off with the switch element 43, the electrical current being generated by the relative rotation between the magnet 41 and the plurality of coils 42, to change the duty ratio and control the braking force of the braking device 4.

The control device 5 has a control unit 51 composed of a microcomputer including a CPU, a storage unit 52 composed of a nonvolatile memory unit, such as EEP ROM or flash memory, a rotational detection unit (rotation detector) 53, a first sensor 54, and a second sensor 55.

The rotational detection unit 53 is configured to detect the rotational speed of the spool 3. The rotational detection unit 53 generates an output signal corresponding to the rotational speed of the spool 3. For example, the rotational detection unit 53 has a Hall clement. The rotational detection unit 53 is attached to the circuit board 20.

The first sensor 54 detects the position of a plurality of first magnets 6c of the first operating member 6, described further below. The second sensor 55 detects the position of a plurality of second magnets 7c of the second operating member 7, described further below. The first sensor 54 and the second sensor 55 are attached to the circuit board 20. The first sensor 54 and the second sensor 55 are disposed inside the outer shape or dimension of the first side cover 9, as viewed from the axial direction. In the present embodiment, the inside of the first side cover 9 means the radially inward side of the outer shape of the first side cover 9.

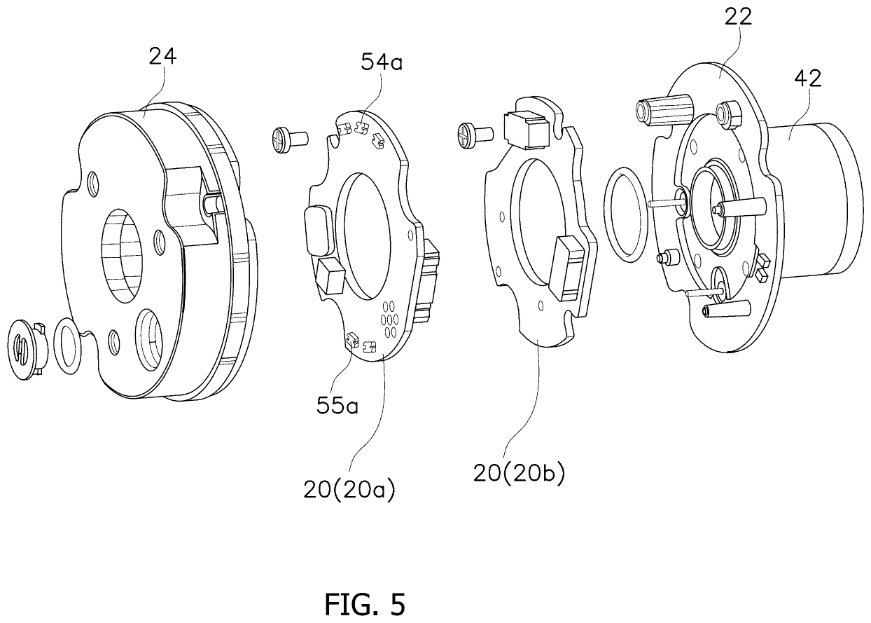

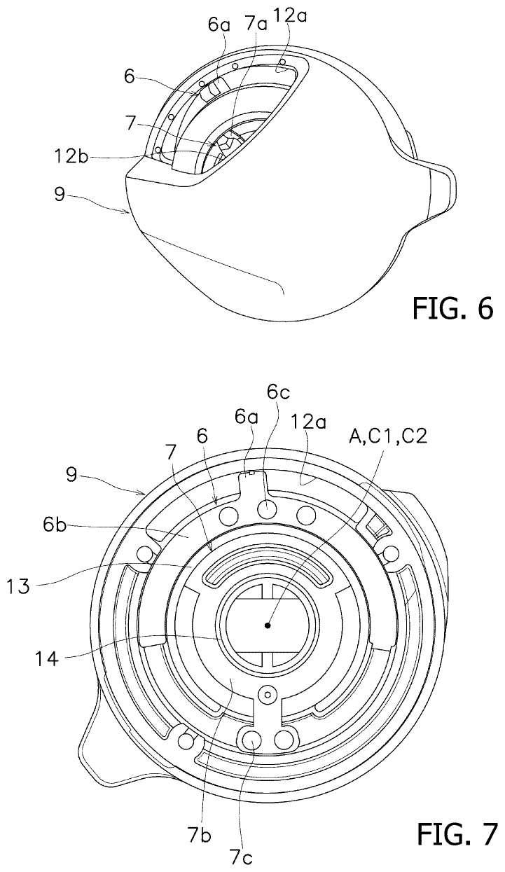

The first sensor 54 and the second sensor 55 are magnetic sensors. As shown in FIG. 5, the first sensor 54 includes three Hall elements 54a. The three Hall elements 54a are arranged spaced apart from each other in the circumferential direction. The second sensor 55 is disposed spaced apart from the first sensor 54 by 180° in the circumferential direction. The second sensor 55 includes two Hall elements 55a. The two Hall elements 55a are arranged spaced apart from each other in the circumferential direction.

The first operating member 6 can select any one of a plurality of braking modes with different braking forces or braking patterns, for example. The plurality of braking modes corresponding to the operating positions of the first operating member 6 are stored in the storage unit 52. An exposed portion 6 is exposed from the first side cover 9. The first operating member 6 can be operated in the rotational direction of the spool 3. The first operating member 6 can be rotated around an axis that is parallel to the rotational axis A of the spool 3. In the present embodiment, the first operating member 6 can be rotated around the rotational axis A of the spool 3. The first operating member 6 has a lever shape.

The first operating member 6 can be operated to or positioned in a plurality of operating positions in the rotational direction of the spool 3. The first operating member 6 is capable of being positioned at five operating positions, for example. The range in which the first operating member 6 can be rotated is a range of 120 degrees or less, for example. The first operating member 6 has a first operating axis C1 positioned inside the outer shape or dimension of the first side cover 9, as viewed from the axial direction. The first operating member 6 is supported by the first side cover 9 so as to be rotatable.

The first operating member 6 is disposed radially and axially inside the outer shape or dimension of the first side cover 9, as viewed from the axial direction. The first operating member 6 is disposed entirely inside the outer shape or dimension of the first side cover 9 within the rotatable range, as viewed from the axial direction. The first operating member 6 is disposed inside the outer shape or dimension of the first flange portion 3b, as viewed from the axial direction. The first operating member 6 is disposed entirely inside the outer shape or dimension of the first flange portion 3b within the rotatable range, as viewed from the axial direction. The first operating member 6 protrudes from the first opening 12a in the radial direction, as viewed from the axial direction.

The first operating member 6 has a first protruding portion 6a, a first support portion 6b, and the plurality of first magnets 6c (one example of a first detected portion). The first protruding portion 6a extends in the radial direction. The first protruding portion 6a extends radially outward from the first support portion 6b. The first protruding portion 6a is exposed from the first opening 12a. The movement of the first protruding portion 6a in the rotational direction of the spool 3 is guided by the first opening 12a. The first operating member 6 can be operated to a plurality of operating positions by the first protruding portion 6a being pressed essentially in the front-rear direction. The first protruding portion 6a, the first support portion 6b, and the plurality of first magnets 6c are arranged inside the first side cover 9 as viewed from the axial direction.

The first support portion 6b extends in an arc shape as viewed from the axial direction. The first support portion 6b is supported by the first supporting protrusion 13 so as to be rotatable.

In one embodiment, the plurality of first magnets 6c includes three magnets. The plurality of first magnets 6c are arranged at positions facing the first sensor 54 in the axial direction. The first sensor 54 detects the positions of the plurality of first magnets 6c to identify the operating position of the first operating member 6. The plurality of first magnets 6c are supported by the first support portion 6b. The plurality of first magnets 6c are arranged spaced apart from each other in the circumferential direction. The N-pole faces of the plurality of first magnets 6c face the first sensor 54.

The second operating member 7 can select any one of a plurality of braking modes of the braking device 4, corresponding to types of fishing line, or the like. In the present embodiment, for example, it is possible to select from four braking modes corresponding to the types of the fishing line, etc. The four braking modes corresponding to the operating positions of the second operating member 7 are stored in the storage unit 52.

A portion of the second operating member 7 is exposed from the first side cover 9. The second operating member 7 can be operated in the rotational direction of the spool 3. The second operating member 7 can be rotated around an axis that is parallel to the rotational axis A of the spool 3. In the present embodiment, the second operating member 7 can be rotated around the rotational axis A of the spool 3. The second operating member 7 has a lever shape.

The second operating member 7 can be operated to a plurality of operating positions in the rotational direction of the spool 3. The second operating member 7 is provided so as to be capable of being positioned at four operating positions, for example. The range in which the second operating member 7 can be rotated is a range of 120 degrees or less, for example. The second operating member 7 has a second operating axis C2 positioned inside the outer shape or dimension of the first side cover 9, as viewed from the axial direction. The second operating member 7 is supported by the first side cover 9 so as to be rotatable.

The second operating member 7 is disposed radially and axially inside the outer shape or dimension of the first side cover 9, as viewed from the axial direction. The second operating member 7 is disposed entirely inside the outer shape or dimension of the first side cover 9 within the rotatable range, as viewed from the axial direction. The second operating member 7 is disposed inside the outer shape or dimension of the first flange portion 3b, as viewed from the axial direction. The second operating member 7 is disposed entirely inside the outer shape or dimension of the first flange portion 3b within the rotatable range, as viewed from the axial direction. The second operating member 7 protrudes from the second opening 12b in the radial direction, as viewed from the axial direction. The second operating member 7 is disposed further inward of the first side cover 9 than the first operating member 6, as viewed from the axial direction.

The second operating member 7 has a second protruding portion 7a, a second support portion 7b, and the plurality of second magnets 7c (one example of a second detected portion). The second protruding portion 7a extends in the radial direction. The second protruding portion 7a is exposed from the second opening 12b. The second operating member 7 can be operated to or positioned in a plurality of operating positions by the second protruding portion 7a that can be pressed essentially in the front-rear direction. The second protruding portion 7a, the second support portion 7b, and the plurality of second magnets 7c are arranged inside the first side cover 9 as viewed from the axial direction.

The second support portion 7b is formed in an essentially annular shape, as viewed from the axial direction. The second support portion 7b is supported by the second supporting protrusion 14 so as to be rotatable.

The plurality of second magnets 7c includes two magnets. The plurality of second magnets 7c are arranged at positions facing the second sensor 55 in the axial direction. The second sensor 55 detects the positions of the plurality of second magnets 7c to identify the operating position of the second operating member 7. The plurality of second magnets 7c are supported by the second support portion 7b. The plurality of second magnets 7c are arranged spaced apart from each other in the circumferential direction. The plurality of second magnets 7c are arranged on the circumference of the same circle as the plurality of first magnets 6c. In the plurality of second magnets 7c, a polarity that is different from the polarity of the plurality of first magnets 6c facing the first sensor 54, faces the second sensor 55. In the present embodiment, the S-pole faces of the plurality of second magnets 7c face the second sensor 55.

Since both the first and second operating members 6, 7 can be operated in the rotational direction of the spool 3, the operability of the two operating members can be improved.

In the fishing reel 100 configured as described above, both the first and second operating members 6, 7 are exposed by the first side cover 9, and both the first and second operating members 6, 7 can be operated in the rotational direction of the spool 3, so that the operability of the first and second operating members 6, 7 can be improved. In addition, the first operating axis C1 of the first operating member 6 and the second operating axis C2 of the second operating member 7 are positioned inside the first side cover 9 as viewed from the axial direction, and the first and second operating members 6, 7 are disposed radially and axially inside the outer shape or dimension of the first side cover 9 as viewed from the axial direction. As a result, the size of the fishing reel 100 can be reduced, and the operability of the first and second operating members 6, 7 can be further improved.

The first opening 12a and the second opening 12b are positioned in front of and above the rotational axis A of the spool 3 as viewed from the axial direction, the first operating member 6 protrudes from the first opening 12a in the radial direction, and the second operating member 7 protrudes from the second opening 12b in the radial direction. It is thereby possible to improve the operability of the first and second operating members 6, 7, and erroneous operation of the first and second operating members 6, 7 can be suppressed, such as when palming.

### OTHER EMBODIMENTS

One embodiment of the present disclosure was described above, but the present disclosure is not limited to the above-described embodiment, and various modifications can be made without departing from the scope of the disclosure.

The first operating member 6 and/or the second operating member 7 can be disposed so as to be rotatable around an axis that is different from the rotational axis A of the spool 3.

The functions of the first and second operating members 6. 7 can be interchanged. That is, the second operating member 7 may be provided for selecting any one of a plurality of braking modes with different braking forces or braking patterns, for example.

What is claimed is:

1. A fishing reel, comprising:
a reel body having a first side plate and a second side plate;
a cover disposed on the first side plate;
a spool disposed between the first side plate and the second side plate;
a braking device configured to apply a braking force to brake rotation of the spool;
a first operating member having a first exposed portion which is exposed by the cover;
a second operating member having a second exposed portion which is exposed by the cover; and
a controller configured to control the braking force of the braking device in accordance with an operating position of the first operating member and an operating position of the second operating member.

2. The fishing reel according to claim 1, wherein
the first operating member has a first operating axis positioned inside an outer dimension of the cover as viewed from a first direction along a rotational axis of the spool, and
the second operating member has a second operating axis positioned inside the outer dimension of the cover as viewed from the first direction.

3. The fishing reel according to claim 1, wherein the first operating member and the second operating member are disposed inside an outer dimension of the cover as viewed from a first direction along a rotational axis of the spool.

4. The fishing reel according to claim 1, wherein
the second operating member is disposed further inward than the first operating member, as viewed from a first direction along a rotational axis of the spool.

5. The fishing reel according to claim 1, wherein
the spool has a bobbin trunk, a first flange portion disposed on a first side adjacent the first side plate of the bobbin trunk, and a second flange portion disposed on the second side plate side of the bobbin trunk, and
the first operating member and the second operating member are disposed inside an outer dimension of the first flange portion as viewed from a first direction along a rotational axis of the spool.

6. The fishing reel according to claim 1, wherein
the cover has an opening accommodating the first operating member and the second operating member, the opening is positioned in front of and above a rotational axis of the spool as viewed from a first direction along the rotational axis of the spool.

7. The fishing reel according to claim 6, wherein
the opening has a first opening accommodating the first operating member, and a second opening accommodating the second operating member.

8. The fishing reel according to claim 7, wherein
the first operating member protrudes from the first opening in a radial direction of a rotational axis of the spool, as viewed from a first direction along the rotational axis of the spool, and
the second operating member protrudes from the second opening in the radial direction of the rotational axis of the spool, as viewed from the first direction.

9. The fishing reel according to claim 1, wherein
at least one of the first operating member and the second operating member is capable of being rotated around a rotational axis of the spool.

10. The fishing reel according to claim 1, wherein
the first operating member includes a first detected portion and a first support portion supporting the first detected portion,
the second operating member includes a second detected portion and a second support portion supporting the second detected portion,
the controller includes a first sensor to detect a position of the first detected portion and a second sensor to detect a position of the second detected portion, and
the first detected portion, the first support portion, the second detected portion, and the second support portion are arranged inside an outer dimension of the cover as viewed from the first direction along the rotational axis of the spool.

11. A fishing reel, comprising:
a reel body having a first side plate and a second side plate;
a cover disposed on the first side plate;
a spool disposed between the first side plate and the second side plate;
a braking device configured to apply a braking force to brake rotation of the spool;
a first operating member configured to be operated in a rotational direction of the spool;
a second operating member configured to be operated in the rotational direction of the spool; and
a controller configured to control the braking force of the braking device in accordance with an operating position of the first operating member and an operating position of the second operating member.

12. The fishing reel according to claim 11, wherein
the first operating member has a first operating axis positioned inside an outer dimension of the cover as viewed from a first direction along a rotational axis of the spool, and
the second operating member has a second operating axis positioned inside the outer dimension of the cover as viewed from the first direction.

13. The fishing reel according to claim 11, wherein the first operating member and the second operating member are disposed inside an outer dimension of the cover as viewed from a first direction along a rotational axis of the spool.

14. The fishing reel according to claim 11, wherein
the second operating member is disposed further inward than the first operating member, as viewed from a first direction along a rotational axis of the spool.

15. The fishing reel according to claim 11, wherein
the spool has a bobbin trunk, a first flange portion disposed on the first side plate side of the bobbin trunk, and a second flange portion disposed on the second side plate side of the bobbin trunk, and
the first operating member and the second operating member are disposed inside an outer dimension of the first flange portion as viewed from a first direction along a rotational axis of the spool.

16. The fishing reel according to claim 11, wherein
the cover has an opening accommodating the first operating member and the second operating member, the opening is positioned in front of and above a rotational axis of the spool as viewed from a first direction along the rotational axis of the spool.

17. The fishing reel according to claim 16, wherein
the opening has a first opening accommodating the first operating member, and a second opening accommodating the second operating member.

18. The fishing reel according to claim 17, wherein
the first operating member protrudes from the first opening in a radial direction of a rotational axis of the spool, as viewed from a first direction along the rotational axis of the spool, and
the second operating member protrudes from the second opening in a radial direction of the rotational axis of the spool, as viewed from the first direction.

19. The fishing reel according to claim 13, wherein
at least one of the first operating member and the second operating member is capable of being rotated around a rotational axis of the spool.

20. The fishing reel according to claim 11, wherein
the first operating member includes a first detected portion and a first support portion supporting the first detected portion,
the second operating member includes a second detected portion and a second support portion supporting the second detected portion,
the controller includes a first sensor to detect a he position of the first detected portion and a second sensor to detect a position of the second detected portion, and
the first detected portion, the first support portion, the second detected portion, and the second support portion are arranged inside the outer dimension of the cover as viewed from the first direction along the rotational axis of the spool.
